(19) United States
(12) Patent Application Publication
(10) Pub. No.: US 2010/0002208 A1
(43) Pub. Date: Jan. 7, 2010

(54) EXPOSURE METHOD, EXPOSURE APPARATUS, AND DEVICE MANUFACTURING METHOD

(75) Inventor: Shinichiro Koga, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/558,450

(22) Filed: Sep. 11, 2009

Related U.S. Application Data
(62) Division of application No. 11/535,660, filed on Sep. 27, 2006.

(30) Foreign Application Priority Data
Oct. 4, 2005 (JP) 2005-291296

(51) Int. Cl. G03B 27/52

(52) U.S. Cl. 355/30

(57) ABSTRACT

At least one exemplary embodiment is directed to a method of exposing a substrate to light, including a measurement step of measuring position of a mark arranged on one of a substrate and a stage configured to hold the substrate and to move; a detection step of detecting a foreign particle on the mark based on a process performed in the measurement step; a removing step of removing the foreign particle on the mark in accordance with detection of the foreign particle in the detection step; a moving step of moving the stage based on the position of the mark measured in the measurement step; and an exposure step of exposing the substrate moved in the moving step to light.

### CROSS-REFERENCE TO RELATED APPLICATIONS

This application is a divisional application of U.S. patent application Ser. No. 11/535,660 filed Sep. 27, 2006, which claims priority to Japanese Patent Application No. 2005-291296 filed Oct. 4, 2005, each of which is hereby incorporated by reference herein in its entirety.

### BACKGROUND OF THE INVENTION

1. Field of the Invention

The present invention relates to an exposure method, an exposure apparatus, and a device manufacturing method. More specifically, though not exclusively, the present invention relates to a technique of accurate alignment of a substrate, such as a semiconductor wafer, and exposing the substrate to light.

2. Description of the Related Art

Recent ICs, LSIs, and other semiconductor integrated circuits or liquid crystal panels are fine and highly integrated. The exposure apparatuses for these semiconductor devices are required to have high performances and execute accurate exposure processing.

For instance, a mask or a reticle (i.e., an original plate) is required to be positioned accurately (on the order of nanometers) relative to a substrate. The practical exposure apparatuses usable in the manufacturing of the semiconductor devices are, for example, steppers and step-and-scan systems.

The steppers and the step-and-scan systems can successively transfer a pattern on an original plate (e.g., reticle) to plural portions on a substrate by stepwise shifting the substrate (e.g., semiconductor wafer).

The stepper is an apparatus capable of performing the transfer processing in a batch manner. On the other hand, the step-and-scan (or a scanner) system is a system capable of performing the transfer processing by scanning a stage.

Next, alignment of an original plate and a substrate, performed by an exposure apparatus, will be described.

A die-by-die alignment method can realize the positioning of an original plate and a substrate in an exposure apparatus, by measuring an exposure position in each exposure processing.

A global alignment method includes steps of performing position measurement at an appropriate number of measuring points, creating a correction equation of the exposure position based on the measurement result, and performing the positioning processing.

The global alignment method is excellent in the throughput and accuracy. The global alignment method is characterized by performing the positioning processing using the same correction equation applied to an entire substrate region. Therefore, according to the global alignment method, the conditions of the positioning processing can be determined by checking several positions within the substrate.

The following conventional methods can be used for detecting an alignment mark.

1. The TTL (through-the-lens) method uses a projection optical system to measure the position of an alignment mark.

2. The OA (off-axis) alignment detection method is capable of directly measuring the position of an alignment mark without using a projection optical system.

When the OA alignment detection method is used for the alignment of an original plate and a substrate, it is necessary to know beforehand a baseline amount which represents a clearance between a measurement center of the alignment detection system and a projection image center of an original plate pattern (i.e., exposure center).

Namely, the positional deviation of a substrate measured by the OA alignment detection system is corrected by the baseline amount. The substrate is shifted by an amount equivalent to the positional deviation. The center of an exposure region (i.e., shot region) is equalized to the exposure center.

However, the baseline amount may gradually vary in the use of the exposure apparatus. If the baseline amount varies, the alignment accuracy (i.e., overlapping accuracy) will deteriorate. Accordingly, a baseline measurement is periodically performed to accurately measure the clearance (baseline amount) between the measurement center of the OA-type alignment detection system and the exposure center.

The foregoing is a brief description with respect to the conventional exposure apparatus and the positioning processing performed by the exposure apparatus.

On the other hand, to respond to the growing demand for fine and highly integrated semiconductor integrated circuits and liquid crystal panels, it is useful to improve the resolution in the exposure apparatus. For example, shortening the wavelength of an exposure light source or increasing the numerical aperture (NA) of the projection optical system.

However, shorting the wavelength of illumination light or increasing the NA value of the projection optical system may bring limited or insufficient effects. Therefore, another conventional method can improve the resolution by filling a space between the projection optical system and the substrate with a substance having higher refractivity compared to air.

For example, pure water or other liquid are examples of substances having higher refractivity compared to air and can be used for a semiconductor exposure apparatus which has a liquid immersed space between the projection optical system and the substrate (generally referred to as “liquid immersion semiconductor exposure apparatus”).

Next, an example of an exposure apparatus and an example of positioning processing performed by the exposure apparatus will be described with reference of FIG. 13.

According to the example arrangement shown in FIG. 13 (referred to as first example), a semiconductor exposure apparatus performs the positioning of a wafer relative to a reticle. The exposure apparatus of FIG. 13 includes an illumination optical system 1, a reticle (i.e., original plate) 2, a projection optical system 3, and a wafer (i.e., substrate) 4. The illumination optical system 1 illuminates the reticle 2. The projection optical system 3 projects an image of the reticle 2 onto the wafer 4.

The exposure apparatus further includes a wafer stage 5, a chuck 6, a wafer stage control unit 7, a pair of TTL alignment detection systems 8a and 8b, an alignment detection system (OA alignment detection system) 9, a height detection unit 10, and a control unit 11. Although not shown in the drawing, a wafer carrying unit (not shown) can put the wafer 4 in position relative to the chuck 6 mounted on the wafer stage 5. The wafer stage control unit 7 can perform the positioning of the wafer stage 5.

A space between the projection optical system 3 and the wafer 4 is filled with liquid 12. A liquid supplying unit 13 can supply the liquid 12 into the space between the projection optical system 3 and the wafer 4. A liquid recovery unit 14 can recover the liquid 12.

Although FIG. 13 illustrates the liquid 12, the liquid supplying unit 13, and the liquid recovery unit 14 as components incorporated into the exposure apparatus, the illustration of FIG. 13 is merely for the sake of convenience.

FIG. 14 is a view showing the wafer stage 5 seen from the optical axis direction of the projection optical system 3.

A reference member 19, having a reference mark comparable with an alignment mark formed on the surface of the wafer 4, is provided on the surface of the wafer stage 5. The reference member 19 does not interfere with the wafer 4. The reticle 2 includes a pair of marks RMa and RMb provided symmetrically about the center C, as shown in FIG. 15.

The reticle 2 is held on a reticle stage (not shown), which has a function of shifting the reticle 2 so that the center C can meet an optical axis AX of the projection optical system 3. The reference mark 19 on the wafer stage 5 can be positioned by the wafer stage 5. The reference mark 19 is located at a predetermined position in a projection field of the projection optical system 3.

The TTL alignment detection system 8a, located above the reticle 2, can simultaneously detect the mark RMa of the reticle 2 and the reference mark. When the wafer stage 5 is shifted to another position, the TTL alignment detection system 8b can simultaneously detect the mark RMb of the reticle 2 and the reference mark.

An alignment detection system 9 is fixed outside the projection field of the projection optical system 3. The alignment detection system 9 has an optical axis parallel to the optical axis of the projection optical system 3.

FIG. 16 is a flowchart showing an example of exposure processing performed by the above-described exposure apparatus.

The flowchart of FIG. 16 includes step S201 (i.e., baseline measuring process). When the mark RMa of the reticle 2 and the reference mark on the reference member 19 are aligned by the TTL alignment detection system 8a, the position of the wafer stage 5 is measured by a laser interferometer (not shown). Similarly, when the mark RMb of the reticle 2 and the reference mark are aligned by the TTL alignment detection system 8b, the position of the wafer stage 5 is measured by the laser interferometer.

When the wafer stage 5 is located at the center (average position) between two wafer stage positions, the reference mark is just on the optical axis of the projection optical system 3 and in a conjugated relationship with the reticle center C.

Similarly, when the reference mark is aligned relative to the alignment detection system 9, the position of the wafer stage 5 is measured by the laser interferometer.

A baseline amount BL can be obtained by calculating a difference between the wafer stage position (above-described average position) obtainable when the reference mark is aligned by the TTL alignment detection systems 8a and 8b and the wafer stage position obtainable when the reference mark is aligned by the alignment detection system 9.

The flowchart of FIG. 16 further includes step S202 (i.e., wafer pattern position measuring process). The wafer pattern position measuring process includes defining an origin as a position where the wafer stage 5 is shifted by the baseline amount measured in the above-described baseline measuring process from the exposure center position, and measuring a positional deviation of a pattern on the wafer relative to the origin.

More specifically, plural alignment mark positions on the wafer 4 are measured by the alignment detection system 9 and a correction equation for the global alignment is created. For example, the measurement processing includes measuring a shift movement of a wafer pattern, an offset amount in magnification, and a rotational amount.

As discussed in Japanese Patent Application Laid-open No. 9-218714 (corresponding to U.S. Pat. No. 5,986,766), a wafer pattern position measuring process is conventionally discussed. As discussed in Japanese Patent Application Laid-open No. 9-218714, a conventional global alignment method can improve the positioning accuracy by correcting higher-order error factors.

The flowchart of FIG. 16 further includes step S203 (i.e., exposure process). The wafer stage 5 is shifted to the exposure position calculated based on the positional deviation of the wafer pattern measured in the wafer pattern position measuring process S202 as well as based on the baseline amount, and the pattern of the reticle 2 is transferred onto the wafer 4.

When the wafer 4 is mounted on the wafer stage 5, the liquid supplying unit 13 can supply the liquid 12 into the space between the projection optical system 3 and the wafer 4. The liquid recovery unit 14 can recover the liquid 12 when the exposed wafer 4 is removed from the wafer stage 5.

The foregoing are characteristic features of the first example, with respect to the positioning of the wafer and the reticle in the liquid immersion semiconductor exposure apparatus.

Another example (i.e., second example) has the following characteristic features with respect to the positioning of the wafer and the reticle in the liquid immersion semiconductor exposure apparatus.

As described previously, it is useful that the semiconductor manufacturing apparatus has highly advanced performances capable of manufacturing recent fine and highly integrated ICs and LSIs.

Moreover, there is pressure for an improvement in productivity due to the increased need for high performance semiconductors such as DRAM. Thus, the semiconductor manufacturing apparatuses not only should improve the accuracy but also should improve the throughput.

Therefore, as discussed in Japanese Patent Publication No. 1-49007 (corresponding to U.S. Pat. No. 4,861,162), a measurement station (i.e., a unit capable of measuring a pattern on a wafer) can be separated from an exposure station (i.e., a unit capable of exposing the wafer to light) In other words, the exposure apparatus can simultaneously perform the measurement processing and the exposure processing.

FIG. 17 is a view illustrating an example of the positioning of a wafer and a reticle.

The exposure apparatus according to the second example includes a measurement station 16 that can measure a relative positional relationship between a wafer chuck and a pattern on the wafer.

Furthermore, the exposure apparatus according to the second example includes an exposure station 17 that can perform exposure processing by projecting the pattern of a reticle onto the wafer, after the relative positional relationship between the reticle and the wafer chuck is measured.

Moreover, the exposure apparatus according to the second example includes a wafer supplying (carrying) unit 15 that can deliver the wafer and the wafer chuck between the measurement station 16 and the exposure station 17, and a control unit 11 that can control the above-described units.

The measurement station 16 includes an alignment detection system 9, a wafer 4a (i.e., a substrate to be exposed), a wafer chuck 6a that can function as a substrate supporting unit capable of mounting and holding the wafer, a wafer stage 5a that can mount the wafer chuck 6a and perform the positioning of the wafer based on position measurement performed by a stage control unit 7a, and a height detection unit 10.

The exposure station 17 includes a projection optical system 3 that can project an image of the reticle 2 onto a wafer 4b, a pair of TTL alignment detection systems 8a and 8b, an illumination optical system 1, a wafer chuck 6b mounting the wafer 4b, and a wafer stage 5b that can mount the wafer chuck 6b and perform the positioning of the wafer 4b based on position measurement performed by a stage control unit 7b.

FIG. 18 is a view showing the wafer chuck 6b seen from the optical axis direction of the projection optical system 3. Two reference members 19a and 19b, each having a reference mark comparable with the alignment mark formed on the surface of the wafer 4b, are fixed on the wafer chuck 6b. The reference members 19a and 19b do not interfere with the wafer 4b.

A space between the projection optical system 3 and the wafer 4b is filled with liquid 12. A liquid supplying unit 13 can supply the liquid 12 (FIG. 17) into the space between the projection optical system 3 and the wafer 4b. A liquid recovery unit 14 can recover the liquid 12.

Although FIG. 17 illustrates the liquid 12, the liquid supplying unit 13, and the liquid recovery unit 14 as members incorporated into the exposure apparatus, the illustration of FIG. 17 is merely for the sake of convenience.

The second example is characterized by the following procedure for projecting the pattern of the reticle 2 onto the wafer 4b.

First, in the measurement station 16, the alignment marks disposed on the wafer chuck 6a and the wafer 4a are measured by the alignment detection system 9. A relative positional relationship between the wafer chuck 6a and the pattern on the wafer 4a is measured based on the positions of the measured alignment marks. In this case, the exposure station 17 performs the exposure processing applied to the wafer 4b according to a later-described procedure.

Next, the wafer supplying unit 15 shifts the exposed wafer 4b and the chuck 6b out of the exposure station 17. Then, the wafer 4a and the wafer chuck 6a are shifted from of the measurement station 16 to the exposure station 17.

In the exposure station 17, an alignment mark position on the wafer chuck 6a is measured by the TTL alignment detection systems 8a and 8b via the reticle 2. A relative positional relationship between the pattern on the reticle 2 and the chuck 6a is measured.

Then, based on the measurement result as well as the relative positional relationship between the wafer chuck 6a and the pattern on the wafer 4a measured in the measurement station 16, a relative positional relationship between the pattern on the reticle 2 and the pattern on the wafer 4a is calculated.

Finally, based on the calculated relative positional relationship between the pattern on the reticle 2 and the pattern on the wafer 4a, the pattern on the reticle 2 is projected on the wafer 4a.

According to the second example, the processing of the measurement station 16 and the processing of the exposure station 17 can be performed simultaneously. Therefore, the time required for the accurate positioning measurement and the wafer exposure processing can be reduced.

According to the above-described arrangement, when the wafer shifts between the measurement station 16 and the exposure station 17, the wafer chuck can function as a substrate supporting unit for supporting the wafer.

However, one can also use the wafer stage 5a and the wafer stage 5b as a substrate supporting unit usable when the wafer is shifted. In this case, instead of detecting the reference mark on the wafer chuck, the reference mark on the wafer stage can be detected similarly.

Next, with reference to a flowchart shown in FIG. 19, exposure processing performed by the above-described exposure apparatus will be described.

The flowchart of FIG. 19 includes step S301 (i.e., measurement position reference mark position measuring process), in which a reference mark position on the wafer chuck 6a is measured by the alignment detection system 9. As shown in FIG. 18, the wafer chuck 6a has at least two reference marks measurable by the alignment detection system 9. The position of the wafer chuck 6a relative to the alignment detection system 9 and a rotational amount can be measured based on measurement of the reference marks.

The flowchart of FIG. 19 includes step S302 (i.e., wafer pattern position measuring process). In the measurement station 16, an alignment mark position on the wafer 6a is measured by the alignment detection system 9. The position of the pattern on the wafer 6a can be identified based on the measurement.

The wafer pattern position measuring process S302 is substantially identical to the wafer pattern position measuring process S202 of the first example. Through the above-described measurement position reference mark position measuring process and the wafer pattern position measuring process, a relative positional relationship between the chuck 6a and the pattern on the wafer 4a can be calculated.

The flowchart of FIG. 19 includes step S303 (i.e., exposure position reference mark position measuring process).

In the exposure station 17, a reference mark position on the wafer chuck 6a is measured by the TTL alignment detection systems 8a and 8b via the reticle 2. Thus, a relative positional relationship (i.e., position and rotational amount) between the pattern on the reticle and the wafer chuck 6a is measured.

The flowchart of FIG. 19 includes step S304 (i.e., exposure process), which determines an exposure position based on the calculated relative positional relationship between the wafer chuck 6a and the pattern on the wafer 4a as well as the relative positional relationship between the pattern on the reticle 2 and the wafer chuck 6a measured in the exposure position reference mark position measuring process.

With reference to the above-described two relative positional relationships, a relative positional relationship between the pattern on the reticle 2 and the pattern on the wafer 4a can be calculated. The wafer stage is shifted to the exposure position determined in this manner, and the pattern on the reticle 2 is transferred onto the wafer 4a through the exposure processing.

In this arrangement, the liquid supplying unit 13 can supply the liquid 12 into the space between the projection optical system 3 and the wafer 4a when the wafer chuck 6b is mounted on the stage 5b of the exposure station 17. The liquid recovery unit 14 can recover the liquid 12 when the exposed wafer 4 is removed from the wafer stage 5b.

The foregoing is characteristic features of the second example, with respect to the positioning of the wafer and the reticle in the liquid immersion semiconductor exposure apparatus.

According to the above-described first and second examples, when a reference mark on the wafer stage or on the chuck is measured by the TTL alignment detection system, the space between the projection optical system and the reference mark on the wafer stage or on the chuck is filled with liquid. On the other hand, when a reference mark on the wafer stage or on the chuck is measured by the alignment detection system, no liquid is supplied on the reference mark.

Therefore, if the liquid remains on the reference mark after the reference mark measurement performed by the TTL alignment detection system is accomplished, a measurement error will arise in the measurement of the reference mark performed by the alignment detection system.

According to the first and second examples, when the reference mark shifts from under the projection optical system, the liquid recovery unit should completely recover the liquid and accordingly no liquid can remain on the reference mark.

However, the reference mark 20 has irregularity as illustrated in a cross-sectional view of FIG. 20. Therefore, a small amount of liquid (e.g., liquid droplet) may remain partially on the reference mark after the liquid recovery unit has recovered the liquid. If the liquid remains at least partially on the reference mark, a reference mark will be captured as a deformed mark image by the alignment detection system. Thus, the measurement value includes an error.

FIG. 21A shows a reference mark seen from above, which includes the same rectangular patterns aligned at the same intervals. If a foreign particle (e.g., droplet) remains on the reference mark shown in FIG. 21A, a deformed mark image will be obtained as shown in FIG. 21C. Accordingly, a deformed mark waveform will be obtained when the mark image is processed according to a later-described method.

FIG. 21B shows a mark waveform obtainable from the mark image shown in FIG. 21A, while FIG. 21D shows a deformed mark waveform obtainable from the mark image including a foreign particle shown in FIG. 21C. Therefore, an error arises in the position measurement of a pattern including a foreign particle according to a later-described method.

Furthermore, according to the liquid immersion exposure apparatus, photosensitive agent (resist) applied on the wafer may adhere on the reference mark via the liquid, or any other foreign particle may remain on the reference mark. Also, the foreign particle is not limited to the above-described particle remaining on the reference mark provided on the wafer stage or on the chuck.

For example, after the pattern of the original plate is transferred onto the substrate by the projection optical system, it may be necessary to measure the overlapped condition of the transferred patterns by the alignment detection system. In this case, a foreign particle may remain on a mark provided on the substrate.

### SUMMARY OF THE INVENTION

At least one exemplary embodiment of the present invention is applicable to an exposure of a substrate to light with a space between a projection optical system and the substrate filled with liquid. At least one exemplary embodiment of the present invention is directed to a novel technique capable of stably and accurately performing position measurement.

According to one aspect of the present invention, at least one exemplary embodiment is directed to a method for exposing a substrate to light, including a measurement step of measuring a position of a mark arranged on one of the substrate and a stage, wherein the stage is configured to hold the substrate and to move; a detection step of detecting a foreign particle on the mark based on a process performed in the measurement step; a removing step of removing the foreign particle on the mark detected in the detection step; a moving step of moving the stage based on the position of the mark measured in the measurement step; and an exposure step of exposing the substrate moved in the moving step to light.

According to another aspect of the present invention, at least one exemplary embodiment is directed to an exposure apparatus configured to expose a substrate to light, including a stage configured to hold the substrate to move; a measurement unit configured to measure a position of a mark arranged on one of the substrate and the stage, and to detect a foreign particle on the mark based on a process of the measurement; a removing unit configured to remove the foreign particle on the mark detected by the measurement unit; and a controller configured to control a position of the stage based on the position of the mark measured by the measurement unit.

According to still another aspect of the present invention, at least one exemplary embodiment is directed to a method of manufacturing a device, comprising steps of: exposing a substrate to light using above-described exposure apparatus; developing the exposed substrate; and processing the developed substrate to manufacture the device.

Further features of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments of the invention and, together with the description, serve to explain at least some of the principles of the invention.

FIG. 1 is a flowchart showing a mark measuring method in accordance with a first exemplary embodiment.

FIG. 2 is a view illustrating a first example of an exposure apparatus.

FIG. 3 is a view illustrating a second example of the exposure apparatus.

FIG. 4 is a view showing an exemplary mark waveform calculation method.

FIG. 5 is a flowchart showing an exemplary mark measuring method.

FIG. 6 is a view showing exemplary pattern clearances.

FIG. 7 is a view showing another exemplary mark waveform calculation method.

FIG. 8 is a view illustrating a first example of a foreign particle removing unit.

FIG. 9 is a view illustrating a second example of the foreign particle removing unit.

FIG. 10 is a view illustrating an example of the reference member.

FIG. 11 is a flowchart showing foreign particle detection processing in accordance with a second exemplary embodiment.

FIGS. 12A to 12C are views illustrating detection of pattern edges.

FIG. 13 is a view illustrating an exposure apparatus according to a first example.

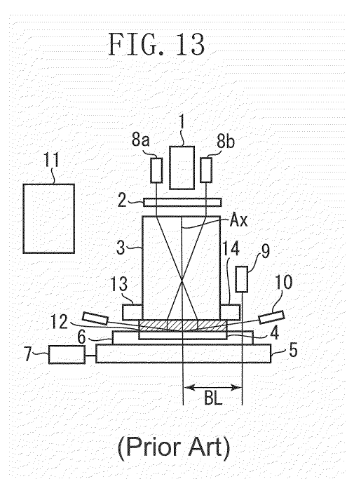

FIG. 14 is a view illustrating a reference member according to the first example.

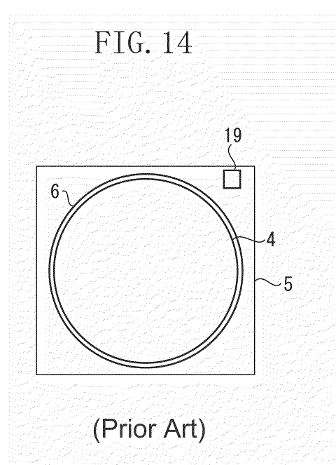

FIG. 15 is a view illustrating a reticle according to the first example.

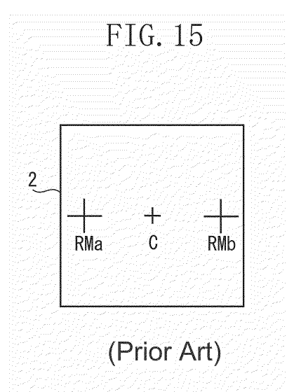

FIG. 16 is a flowchart showing an exposure method according to the first example.

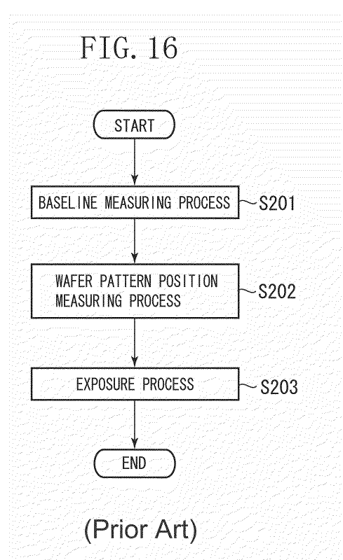

FIG. 17 is a view illustrating an exposure apparatus according to a second example.

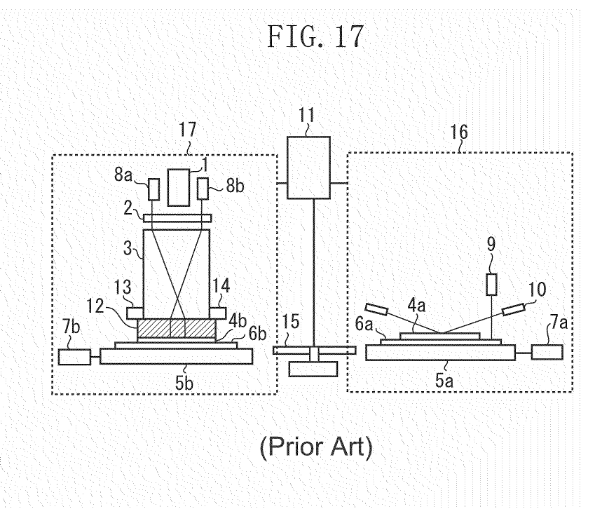

FIG. 18 is a view illustrating a reference member according to the second example.

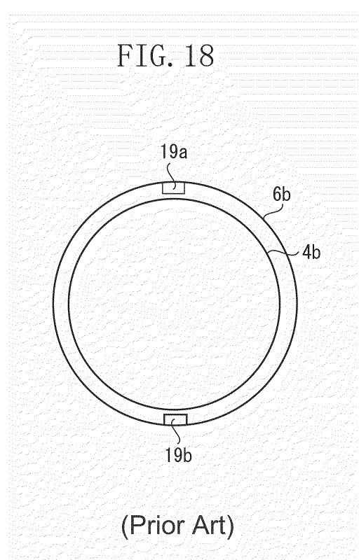

FIG. 19 is a flowchart showing an exposure method according to the second example.

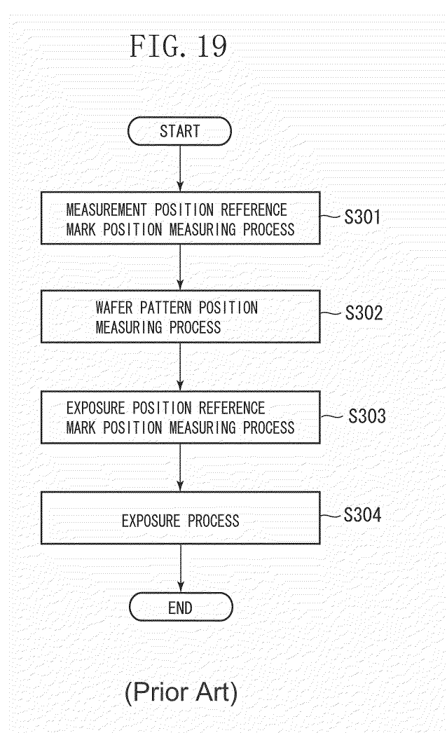

FIG. 20 is a cross-sectional view showing a reference mark.

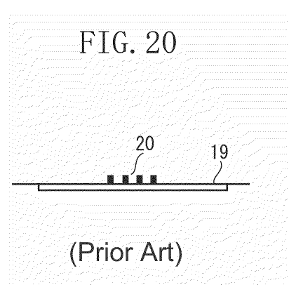

FIGS. 21A to 21D are views illustrating a mark image including a foreign particle and a mark waveform obtained.

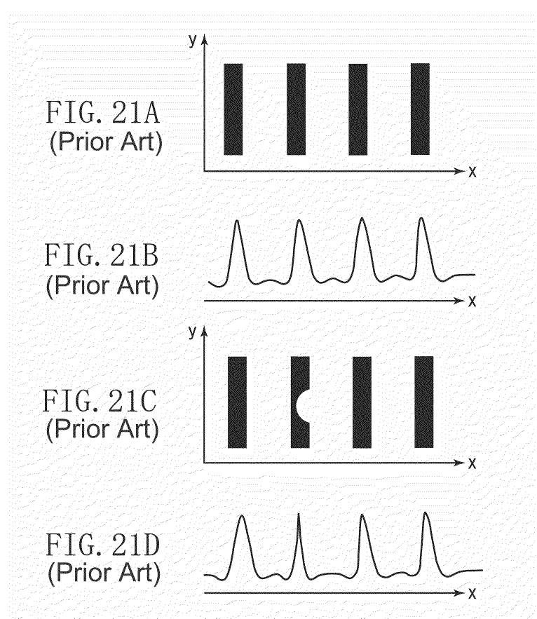

FIG. 22 is a flow diagram showing a device manufacturing process.

### DETAILED DESCRIPTION OF THE EMBODIMENTS

The following description of exemplary embodiments is merely illustrative in nature and is in no way intended to limit the invention, its application, or uses.

Processes, techniques, apparatus, and materials as known by one of ordinary skill in the art may not be discussed in detail but are intended to be part of the enabling description where appropriate.

It is noted that throughout the specification, similar reference numerals and letters refer to similar items in the following figures, and thus once an item is defined in one figure, it may not be discussed for following figures.

Exemplary embodiments will be described in detail below with reference to the drawings.

### First Exemplary Embodiment

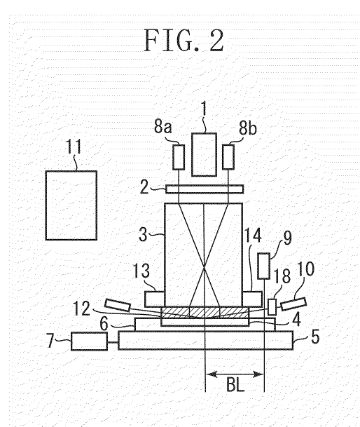

The first exemplary embodiment of the present invention will be described below. FIG. 2 is a view illustrating one example of an exposure apparatus according to the first exemplary embodiment, incorporated in the above-described first example. The exposure apparatus shown in FIG. 2 includes a foreign particle removing unit 18, and can be identical to the above-described first example in other arrangements.

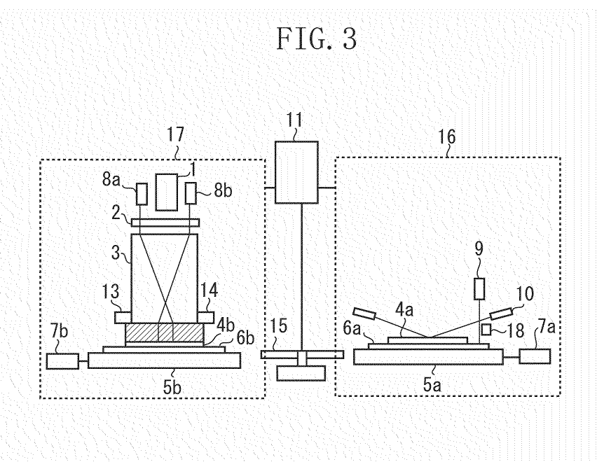

FIG. 3 is a view illustrating one example of an exposure apparatus according to the first exemplary embodiment, incorporated in the above-described second example. The exposure apparatus shown in FIG. 3 includes the foreign particle removing unit 18, and can be identical to the above-described second example in other arrangements. The detailed arrangement of the foreign particle removing unit 18 will be described later.

Next, an exposure method performed by the exposure apparatus according to the present exemplary embodiment will be described below with reference to FIGS. 2 and 3. The present exemplary embodiment is similar to the first and second examples except the method for measuring a reference mark by the alignment detection system.

The method for measuring a reference mark by the alignment detection system will be described below in detail.

In the present exemplary embodiment, the method for measuring a reference mark by the alignment detection system includes a step of detecting a foreign particle on the mark (i.e., determining the presence of a foreign particle) in the process of measuring the position of a mark by the alignment detection system, and a step of again measuring the mark after the foreign particle is removed when such a foreign particle is present on the mark.

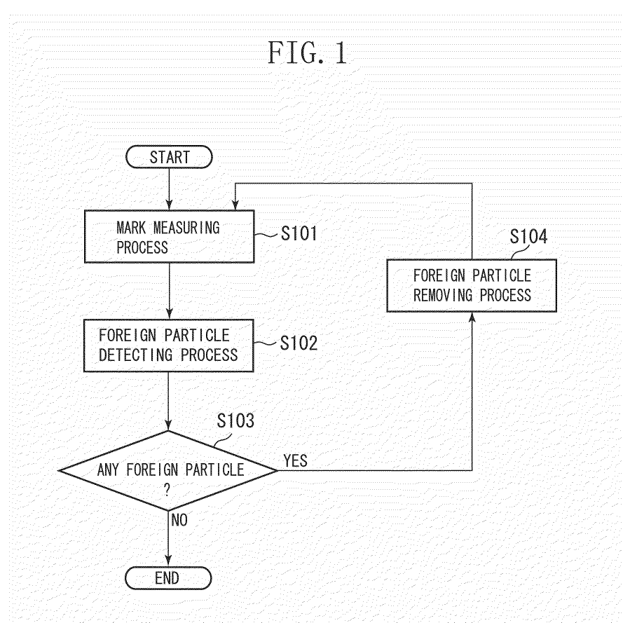

FIG. 1 is a flowchart showing a method for measuring a reference mark or an alignment mark or an overlapped mark (collectively referred to as “alignment mark” or “mark”) on a substrate, realized by the alignment detection system.

In step S101 (i.e., a mark measuring process), the alignment detection system measures an alignment mark position using the following method.

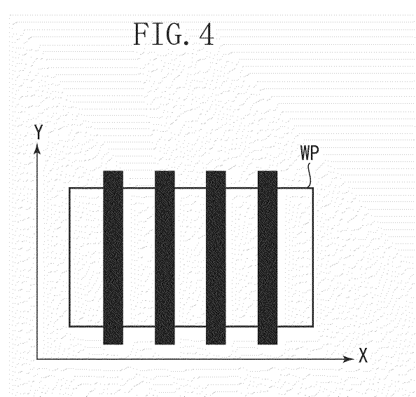

First of all, a mark waveform of a reference mark is input. For example, the light reflected from the reference mark shown in FIG. 4 is captured by a photoelectric conversion element, such as a CCD camera or CMOS.

A processing window WP is set for a 2-dimensional image of a captured mark image as shown in FIG. 4. The accumulation processing is performed in the Y direction within the processing window WP, to convert a 2-dimensional mark image into a 1-dimensional mark waveform S(x).

Next, the position of the reference mark is calculated based on the mark waveform S(x). As a practical method, the same processing is repetitively applied to respective rectangular patterns to measure the position of each rectangular pattern. Then, the position of the reference mark can be obtained as an average value.

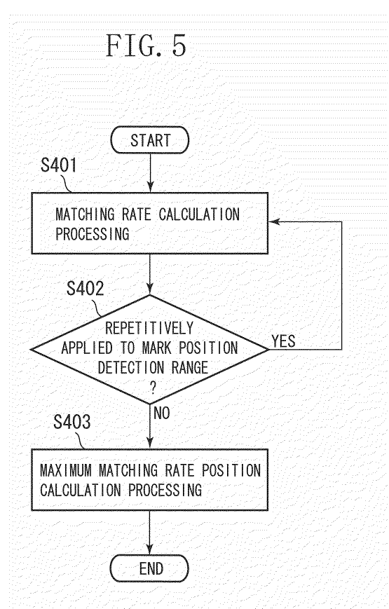

FIG. 5 is a flowchart showing a method for measuring each rectangular pattern position.

The measurement of each rectangular pattern position can be realized using a template matching method including step S401 (i.e., matching rate calculation processing), step S402 (i.e., decision processing for checking whether the processing of step S401 is repetitively applied to a mark position detection range), and step S403 (i.e., maximum matching rate position calculation processing). Hereinafter, each processing will be described below in more detail.

Step S401 includes the processing of calculating a matching rate based on a comparison between the mark waveform and a preset template waveform. The matching rate can be calculated based on a difference between the mark waveform and the template waveform.

The following equation expresses a matching rate r(x) at a position x on the mark waveform.

$$r ( x ) = \frac{1}{{\sum }_{k = - w / 2}^{w / 2} \vert S ( x + k ) - T ( k ) \vert}$$

In the above-described equation, S(x) represents the mark waveform, T(x) represents the template waveform, and w represents a waveform width required for calculating the matching rate and also represents a template width.

Step S403 includes the processing of obtaining a position where the matching rate calculated in step S401 is maximized and identifying the obtained position as the mark center position.

The position where the matching rate is maximized can be obtained by applying centroid calculation or quadratic function approximation to the matching rate at each position x, with the accuracy lower than the resolution of a sensor (photoelectric conversion element).

For example, the following equation can be used to obtain a mark center position Mc based on the centroid calculation.

$$Mc = \frac{{\sum }_{k = ss}^{se} r ( k ) k}{{\sum }_{k = ss}^{se} r ( k )}$$

In the equation, ss and se represent a start position and an end position of the matching rate used in the centroid calculation, determined beforehand.

In the above-described mark measuring processing, a mark is used for position measurement in the X direction. It is, however, possible to use another mark perpendicular to the above-described mark for position measurement in the Y direction.

Next, in step S102, a foreign particle on the mark is detected based on the measurement value obtained in the mark measuring process. The foreign particle detection processing can be realized by using erroneous measurement or detection of predetermined deterioration in the measurement accuracy, as discussed in Japanese Patent Application Laid-open No. 2001-319858.

More specifically, according to the method discussed in Japanese Patent Application Laid-open No. 2001-319858, a foreign particle can be detected based on clearances between separate mark portions (i.e., between rectangular elements) constituting an alignment mark.

Namely, if a foreign particle is present on a rectangular pattern, the measurement value will include an error. Clearances between rectangular pattern positions become uneven. Thus, the presence of a foreign particle can be detected based on the unevenness of the clearances.

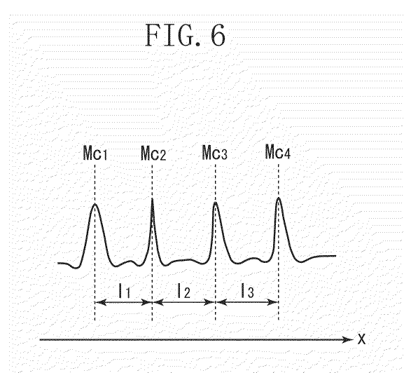

First of all, as shown in FIG. 6, the clearance of rectangular patterns is calculated based on the measured positions of respective rectangular patterns obtained in step S101.

According to a mark shown in FIG. 6, I1 represents a first rectangular pattern clearance between two rectangular pattern positions Mc1 and Mc2. I2 represents a second rectangular pattern clearance between two rectangular pattern positions Mc2 and Mc3. And, I3 represents a third rectangular pattern clearance between two rectangular pattern positions Mc3 and Mc4. The rectangular pattern clearances can be calculated using the following equation.

Iₖ=M_{c(k+1)}−M_{ck}

Next, a difference between each calculated clearance and a design value I0 of the rectangular pattern clearance is calculated. When the calculated difference is greater than a predetermined threshold, it is decided than a foreign particle is present.

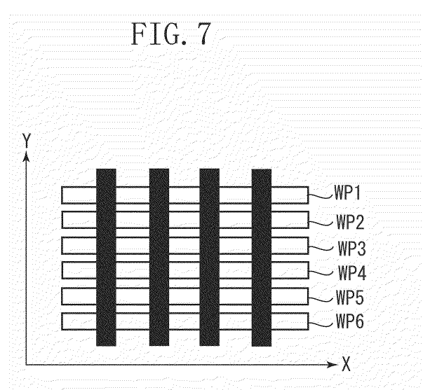

According to the example shown in FIG. 4, one mark waveform is created in one processing window. However, as shown in FIG. 7, it is possible to set a plurality of processing windows (WP1 to WP6) to create a plurality of mark waveforms, so that a small foreign particle can be detected.

When no foreign particle is detected in the foreign particle detection process (i.e., NO in step S103), a value measured in the mark measuring process is regarded as a measurement value. When a foreign particle is detected in the foreign particle detection process (i.e., YES in step S103), the foreign particle is removed in the next step S104 (i.e., foreign particle removing process). In other words, the foreign particle removing process in the step S104 is performed based on a measurement value obtained in the mark measuring process. Then, the mark measuring process (step S101) is again performed.

In the step S104, the foreign particle on the mark is removed by the foreign particle removing unit 18.

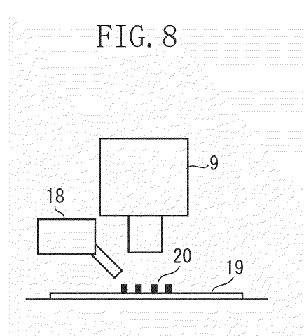

FIG. 8 shows a schematic arrangement including the foreign particle removing unit 18, the alignment detection system 9, the reference mark 20 on the wafer stage or on the chuck (or the mark on the substrate), and the reference member (or substrate) 19.

The foreign particle removing unit 18 is, for example, equipped with a suction or spray mechanism that can remove liquid or a foreign particle as shown in FIG. 8. In the present exemplary embodiment, the foreign particle removing unit 18 can be easily configured to remove the liquid and/or a foreign particle on an alignment mark having a small area and located at a known position.

According to the exemplary arrangement shown in FIG. 8, the foreign particle removing unit 18 can be positioned near the alignment detection system 9. However, it is possible to locate the foreign particle removing unit 18 at a distant place, as long as it can perform the function.

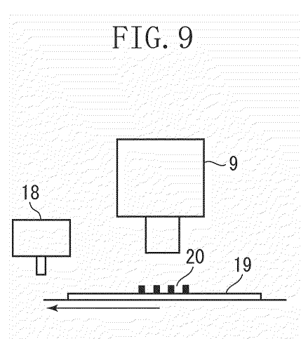

As shown in FIG. 9, it is possible to shift the wafer stage so that the alignment mark can be placed in a processing object area of the foreign particle removing unit 18 and a foreign particle can be removed by the foreign particle removing unit 18. According to the FIG. 9 arrangement, it is possible to reduce the chance that the removed foreign particles will adhere to the alignment detection system 9.

The above-described first exemplary embodiment is based on a reference mark provided on the wafer stage or on the chuck. However, a similar mark position measurement can be realized for an alignment mark on the wafer.

Furthermore, the above-described first exemplary embodiment is based on an exposure method and an exposure apparatus for projecting the pattern of an original plate onto a substrate via a liquid immersed space between the projection optical system and the substrate. However, the present invention is employable in any case where a foreign particle is present on a mark. Thus, the present invention is not limited to the liquid immersion exposure method and apparatus and can be applied to other exposure method and apparatus.

As described above, the present exemplary embodiment can detect liquid or a foreign particle adhering to a reference mark disposed on the wafer stage or on the chuck, or adhering to a mark disposed on the substrate, and can remove the detected liquid or foreign particle. Thus, the present exemplary embodiment can perform a stable and accurate position measurement.

Furthermore, the above-described exemplary embodiment can be modified in the following manner.

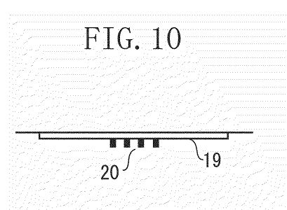

Although, in the above-described exemplary embodiment, each pattern of the reference mark is disposed on an upper surface of a pattern support member (i.e., on a surface facing to the alignment detection system), each pattern can be provided on a lower surface of a transparent support member as shown in FIG. 10. In other words, the reference mark can be disposed on a surface not facing the alignment detection system.

This arrangement is useful in that the liquid can contact with a flat surface of the pattern support member, in the measurement of the reference mark performed by the TTL alignment detection system. This arrangement is thus effective to reduce a liquid droplet remaining as a foreign particle on the reference mark.

Furthermore, it can be useful to coat a water-repellent film on the pattern and on the pattern support member, to reduce the liquid droplet (i.e., foreign particle) remaining on the reference mark.

### Second Exemplary Embodiment

A second exemplary embodiment of the present invention will be described below. According to the first exemplary embodiment, a foreign particle is detected based on the clearances between measurement values (positions) of patterns (e.g., rectangular patterns, although any type of pattern can be used so long as the clearances can be determined)

The second exemplary embodiment uses another method for detecting a foreign particle. The second exemplary embodiment is similar to the first exemplary embodiment but is differentiated in the foreign particle detection process.

The present exemplary embodiment proposes a method for measuring a mark by the alignment detection system, includes a step of detecting a foreign particle on a mark based on the linearity of respective rectangular patterns, and a step of again measuring the mark after the foreign particle is removed if such a foreign particle is detected on the mark.

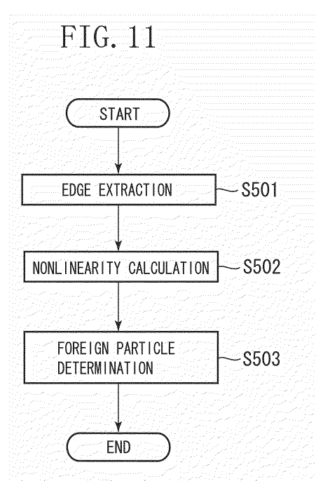

FIG. 11 is a flowchart showing the contents of the foreign particle detection step S102 according to the second exemplary embodiment.

In step S501, an edge line extending in the non-measurement direction (Y direction in FIG. 4) is extracted from a 2-dimensional image of the reference mark. The edge can be obtained according to a method including a step of differentiating the 2-dimensional image in the measurement direction (i.e., X direction shown in FIG. 4) and a step of identifying an edge when a differential value exceeds a predetermined threshold.

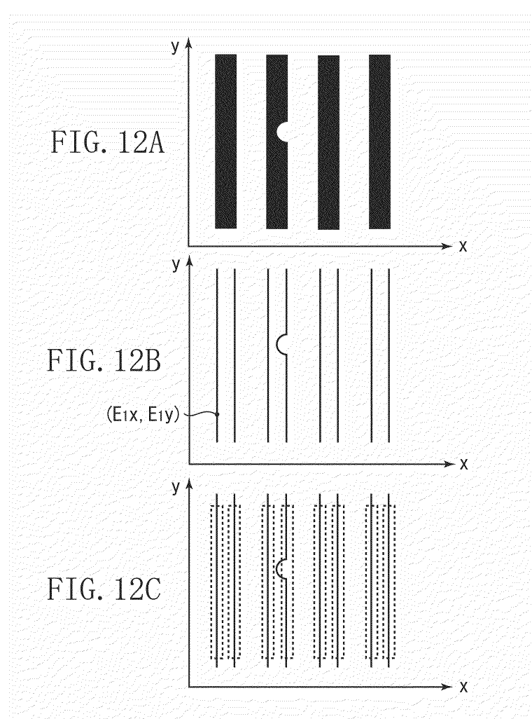

FIG. 12A shows an exemplary image of a mark including a foreign particle. FIG. 12B shows an example of edge lines extending in the non-measurement direction (i.e., Y direction) extracted from the image shown in FIG. 12A. The position of each extracted edge can be expressed by the coordinate values (E1x, E1y), . . . , (Enx, Eny), where n represents the total number of extracted edges).

In step S502, the nonlinearity of the edge in each rectangular pattern is calculated.

FIG. 12C shows a dotted line surrounding a region of each pattern where an approximated straight line of each edge is obtained. Each region can be calculated based on a center position of each rectangular pattern calculated in the mark measuring process and a design value of the width of the rectangular pattern.

Furthermore, the approximated straight line can be obtained by applying straight line approximation (e.g., as least squares method) to the edge position obtained in step S501. It can now be assumed, for this non-limiting example of the second exemplary embodiment, that the calculated straight line is x=Ay+B.

Finally, a difference between the calculated straight line and the edge position obtained in step S501 in the measurement direction (i.e., the X direction in FIG. 4) can be calculated for each edge. Then, calculated differences are summed up. The obtained sum represents the nonlinearity of each rectangular pattern edge.

The difference Dm between the calculated straight line and the edge position obtained in step S501 in the measurement direction can be expressed by the following equation.

Dm=|AE_{1y}+B−E₁ₓ|

The nonlinearity D0, i.e., a sum of differences Dm, can be expressed by the following equation.

$${D}_{0} = {\sum }_{m = 1}^{n} Dm$$

In step S503, when the nonlinearity D0 of each rectangular pattern edge obtained in step 502 exceeds a predetermined threshold, it is decided that a foreign particle is present on the reference mark.

As described above, similar to the first exemplary embodiment, the above-described second exemplary can detect liquid and/or a foreign particle adhering to the reference mark disposed on the wafer stage or on the chuck, or adhering to the mark disposed on the substrate, and can remove the detected liquid or foreign particle. Thus, the above-described second exemplary embodiment can realize stable and accurate position measurement.

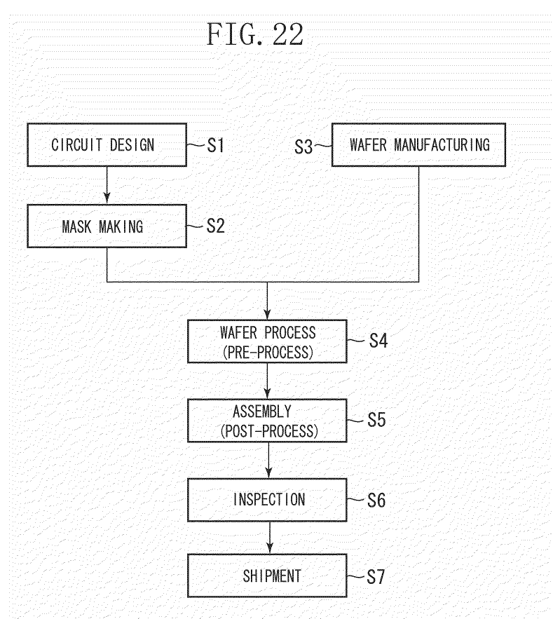

Next, an exemplary manufacturing processes of a semiconductor device performed by the above-described exposure apparatus will be described with reference to a flow diagram of FIG. 22.

The device manufacturing flow of FIG. 4 includes step S1 (i.e., circuit design) for executing circuit design of a semiconductor device, step S2 (i.e., mask making) for fabricating a mask based on a designed circuit pattern, step S3 (i.e., wafer manufacturing) for fabricating a wafer from a silicon or other material, and step S4 (i.e., wafer process) serving as a pre-process. In the wafer process step S4, the exposure apparatus forms an actual circuit on the wafer with the above-described mask utilizing, for example, the lithography technique.

The device manufacturing flow of FIG. 22 further includes step S5 (assembly) serving as a post-process, step S6 (inspection), and step S7 (shipment). The assembly step S5 includes an assembly process (e.g., dicing, bonding, etc) and a packaging process (e.g., chip sealing) to form a semiconductor chip from the wafer manufactured in step S4. The inspection step S6 includes an operation check test and an endurance test applied to the semiconductor device formed in the step S5. The semiconductor device finished through the above-described steps is sent to the shipment step S7.

The wafer process step S4 can include an oxidation step of oxidizing the surface on a wafer, a CVD step of forming an insulation film on the wafer surface, an electrode forming step of forming an electrode on the wafer by vaporization, an ion implantation step of implanting ions into the wafer, a resist processing step of applying photosensitive agent to the wafer, an exposure step of transferring a circuit pattern onto the resist processed wafer using the exposure apparatus, a developing step of developing the wafer exposed in the exposure step, an etching step of removing a region other than the resist image developed in the developing step, and a resist peeling step of removing the unnecessary resist.

By repeating the above-described steps, a multilayered circuit patterns can be formed on the wafer.

As understood from the foregoing description, the above-described exemplary embodiment can provide a novel technique capable of realizing stable and accurate position measurement.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

What is claimed is:

1. A method of exposing a substrate to light with a space between a projection optical system and the substrate filled with liquid, the method comprising:
a measurement step of measuring a position of a mark arranged on a member on a stage, wherein the stage is configured to hold the substrate and to move;
a detection step of detecting the liquid on the mark based on a process performed in the measurement step;
a removing step of removing the liquid on the mark detected in the detection step;
a second measurement step of measuring the position of the mark with the space between the projection optical system and the member filled with liquid;
a moving step of moving the stage based on the position of the mark measured in the second measurement step; and
an exposure step of exposing the substrate moved in the moving step to light.

2. A method according to claim 1, wherein the measurement step again measures the position of the mark from which the liquid is removed in the removing step.

3. A method according to claim 1, wherein the detection step detects the liquid based on positions of plural elements of the mark obtained in the measurement step.

4. A method according to claim 3, wherein the detection step detects the liquid based on a distance between at least two of the plural elements.

5. A method according to claim 1, wherein the detection step detects the liquid based on a linearity of an element of the mark.

6. A method according to claim 1, wherein the removing step removes the liquid by moving the mark to a region within which a liquid removing unit operates.

7. A method according to claim 1, wherein the removing step removes the liquid by at least one of suction of the liquid and blowing gas to remove the liquid.

8. An exposure apparatus for exposing a substrate to light with a space between a projection optical system and the substrate filled with liquid, the apparatus comprising:
a stage configured to hold the substrate and to move;
a measurement unit configured to measure a position of a mark arranged on one of the substrate and a member on the stage, and to detect a liquid on the mark based on a process of the measurement;
a removing unit configured to remove the liquid on the mark detected by the measurement unit;
a second measurement unit configured to measure the position of the mark with the space between the projection optical system and the member filled with liquid; and
a controller configured to control a position of the stage based on the position of the mark measured by the measurement unit and the second measurement unit.

9. An apparatus according to claim 8, wherein the measurement unit is configured to again measure the position of the mark from which the liquid is removed by the removing unit.

10. An apparatus according to claim 8, wherein the measurement unit is configured to detect the liquid based on positions of plural elements of the mark.

11. An apparatus according to claim 10, wherein the measurement unit is configured to detect the liquid based on a distance between at least two of the plural elements.

12. An apparatus according to claim 8, wherein the measurement unit is configured to detect the liquid based on a linearity of an element of the mark.

13. An apparatus according to claim 8, wherein the removing unit is configured to remove the liquid on the mark moved with the stage to a region within which the removing unit operates.

14. An apparatus according to claim 8, wherein the removing unit is configured to remove the liquid by at least one of suction of the liquid and blowing gas to remove the liquid.

15. An apparatus according to claim 8, wherein the member is transparent, and the mark is provided on a surface of a member disposed on the stage, the surface being opposed to a second surface facing the measurement unit.

16. An apparatus according to claim 8, wherein the mark is coated with a liquid-repellent film.

17. A method of manufacturing a device, the method comprising steps of:
exposing a substrate to light using an exposure apparatus as defined in claim 8;
developing the exposed substrate; and
processing the developed substrate to manufacture the device.
